(19) United States
(12) Patent Application Publication
(10) Pub. No.: US 2025/0370637 A1
(43) Pub. Date: Dec. 4, 2025

(54) DATA PROCESSING DEVICE AND BIOLOGICAL SENSOR

(71) Applicants: Nitto Denko Corporation, Ibaraki-shi, Osaka (JP); SPChange, LLC., Yokohama-shi, Kanagawa (JP)

(72) Inventors: Ryoma YOSHIOKA, Ibaraki-shi, Osaka (JP); Takatsugu KAMATA, Yokohama-shi, Kanagawa (JP); Yusaku HIRAI, Yokohama-shi, Kanagawa (JP); Masayuki UEDA, Yokohama-shi, Kanagawa (JP)

(21) Appl. No.: 19/104,768

(22) PCT Filed: Aug. 23, 2023
(86) PCT No.: PCT/JP2023/030278

§ 371 Date: Feb. 19, 2025

(30) Foreign Application Priority Data
Aug. 25, 2022 (JP) 2022-133919

(51) Int. Cl. G06F 3/06

(52) U.S. Cl. CPC G06F 3/0625; G06F 3/0659; G06F 3/0673

(57) ABSTRACT

The data processing device includes a memory, a controller, and a processor. The memory includes a first buffer and a memory array, and writes data held in the first buffer to the memory array based on receiving a write command. The controller transfers data received from outside to the first buffer, and outputs a trigger signal based on the transfer of a predetermined amount of data to the first buffer. The processor transmits a write command to the memory based on receiving the trigger signal. Thus, even in a case where one of memories having various command specifications is implemented in the data processing device, the data can be written into the memory while reducing an increase in power consumption of the processor.

### TECHNICAL FIELD

The present invention relates to data processing devices and biological sensors.

### BACKGROUND ART

For example, a biological sensor that acquires biological information from a living body includes an integrated circuit that acquires the biological information as a voltage and converts the acquired voltage into digital data, and a Micro-Processing Unit (MPU) that controls the entire operation of the biological sensor. The MPU writes the digital data (biological information) received from the integrated circuit into a memory (for example, refer to Patent Document 1).

### PRIOR ART DOCUMENTS

### Patent Documents

Patent Document 1: Japanese Laid-Open Patent Publication No. 2020-163128

### DISCLOSURE OF THE INVENTION

### Problem to be Solved by the Invention

In the case where biological information is written to the memory by the MPU that controls the overall operation of the biological sensor, memories with various command specifications can be implemented in the biological sensor by modifying a program executed by the MPU. However, in the case where the biological information is written into the memory under the control of the MPU, a utilization rate of the MPU increases, thereby increasing a power consumption of the MPU.

On the other hand, in a case where the integrated circuit that acquires the biological information writes the biological information into the memory without using the MPU, an increase in the power consumption of the MPU is reduced, but in the case where the memory having the different command specification is implemented in the biological sensor, it is necessary to redesign the integrated circuit.

The present invention is conceived in view of the above, and one object of the present invention is to provide a data processing device and a biological sensor that can write data into a memory while reducing an increase in a power consumption of a processor, even in a case where one of memories having various command specifications is implemented.

### Means of Solving the Problem

A data processing device according to an embodiment of the present invention is characterized in that there are provided a memory including a first buffer configured to hold data and a memory array, the memory being configured to write the data held in the first buffer to the memory array based on receiving a write command; a controller configured to transfer data received from an outside to the first buffer, and output a trigger signal based on transfer of a predetermined amount of data to the first buffer; and a processor configured to transmit the write command to the memory based on receiving the trigger signal.

### Effects of the Invention

According to the disclosed technique, it is possible to provide a data processing device and a biological sensor that can write data into a memory while reducing an increase in a power consumption of a processor even in a case where one of memories having various command specifications is implemented.

### BRIEF DESCRIPTION OF THE DRAWINGS

FIG. 1 is an overall block diagram illustrating an example of a data processing device according to an embodiment.

FIG. 2 is a sequence diagram illustrating an example of an operation of the data processing device illustrated in FIG. 1.

FIG. 3 is an explanatory diagram illustrating an example of a state of a signal in each step of the operation sequence of FIG. 2.

FIG. 4 is an overall block diagram illustrating an example of a biological sensor according to an embodiment.

FIG. 5 is a flow chart illustrating an example of an operation of the biological sensor of FIG. 4.

FIG. 6 is a flow chart illustrating a continuation of FIG. 5.

### MODE OF CARRYING OUT THE INVENTION

Hereinafter, embodiments for carrying out the invention will be described with reference to the drawings. In the following description, the same symbol as a signal name is used for a signal line through which information such as a signal is transmitted. Further, the same symbol as a voltage name is used for a voltage line through which a voltage is transmitted. In the drawings, the same constituent elements are designated by the same reference numerals, and a redundant description thereof may be omitted.

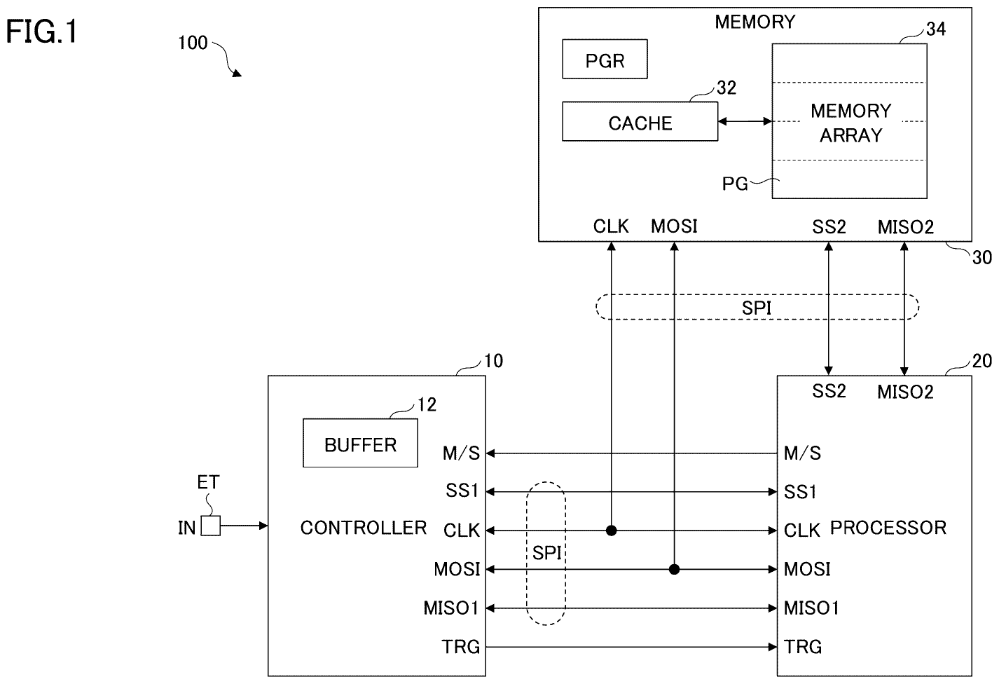

FIG. 1 is an overall block diagram illustrating an example of a data processing device according to an embodiment. A data processing device 100 illustrated in FIG. 1 includes a controller 10 including a buffer 12, a processor 20, and a memory 30 including a page register PGR, a cache 32, and a memory array 34. The memory array 34 includes a plurality of pages PG which are data write units. For example, the controller 10, the processor 20, and the memory 30 are implemented in a substrate of the data processing device 100. The cache 32 is an example of a first buffer, and the buffer 12 is an example of a second buffer.

For example, the controller 10 may be implemented in an Application Specific Integrated Circuit (ASIC) or a Field-Programmable Gate Array (FPGA). In addition, the controller 10 and the processor 20 may be implemented in a single FPGA. For example, the memory 30 is a nonvolatile memory, such as a flash memory or the like, that is electrically rewritable and having a serial interface. The memory may have data terminals of a plurality of bits, or may be a volatile memory.

For example, the controller 10, the processor 20, and the memory 30 are connected to one another via a Serial Peripheral Interface (SPI). The controller 10, the processor 20, and the memory 30 may be connected to one another via a serial interface other than the SPI.

A clock signal line CLK and a serial signal line Master Output Slave Input (MOSI) of the SPI connect the controller 10, the processor 20, and the memory 30 to one another. The serial signal line MOSI is an example of a common data line and a common serial data line. A slave select line SS1 (Slave Select) and a serial signal line Master Input Slave Output (MISO) 1 connect the controller 10 and the processor 20 to each other.

The slave select line SS2 and the serial signal line MISO2 connect the processor 20 and the memory 30 to each other. In addition, a master-slave signal line M/S and a trigger signal line TRG are wired between the controller 10 and the processor 20.

Hereinafter, signals transmitted to the clock signal line CLK and the serial signal lines MOSI, MISO1, and MISO2 are also referred to as a CLK signal, a MOSI signal, a MISO1 signal, and a MISO2 signal, respectively. Signals transmitted to the slave select lines SS1 and SS2 are also referred to as a SS1 signal and a SS2 signal, respectively. A master-slave signal M/S transmitted to the master-slave signal line M/S and a trigger signal TRG transmitted to the trigger signal line TRG are also referred to as a M/S signal and a TRG signal, respectively.

For example, the clock signal line CLK, the serial signal lines MOSI, MISO1, and MISO2, and the slave select lines SS1 and SS2 are pulled up. The CLK signal, the MOSI signal, the MISO1 signal, the MISO2 signal, the SS1 signal, and the SS2 signal are bi-directional signals. The SS2 signal is an example of a chip select signal for selecting the memory 30, and the processor 20 has a function to output the SS2 signal to a SS2 terminal of the memory 30. The slave signal terminal SS2 of the memory 30 is an example of a chip select terminal.

The M/S signal is output from the processor 20 to the controller 10. The M/S signal is set to a low level (=logical value 0) while the controller 10 is set as a slave, and in this state, the processor 20 becomes a master. Further, the M/S signal is set to a high level (=logical value 1) while the controller 10 is set as the master, and in this state, the processor 20 becomes the slave.

The TRG signal is output from the controller 10 to the processor 20. The TRG signal indicates a completion of transfer of a predetermined amount of data from the controller 10 to the cache 32 of the memory 30. For example, the predetermined amount is an amount of data corresponding to a storage capacity of each page PG. The processor 20 instructs the memory 30 to write (program) the data held in the cache 32 to the memory array 34, based on receiving the TRG signal.

The processor 20 may detect the completion of the data transfer from the controller 10 to the cache 32 by a SS1 signal. In this case, the trigger signal line TRG does not need to be wired between the controller 10 and the processor 20. The controller 10 sets the SS1 signal from the logical value 1 to the logical value 0 at a start of the data transfer to the cache 32, and holds the logical value 0 of the SS1 signal during the data transfer. The controller 10 sets the SS1 signal from the logical value 0 to the logical value 1 upon completion of the data transfer to the cache 32. Further, the processor 20 detects the start of the data transfer to the cache 32, based on a transition of the SS1 signal from the logical value 1 to the logical value 0, and detects a completion of data transfer of one page to the cache 32, based on a transition of the SS1 signal from the logical value 0 to the logical value 1.

The controller 10 receives an input data signal IN via an external terminal ET of the data processing device 100, and stores the received input data signal IN in the buffer 12 as data. For example, the buffer 12 has a storage capacity that is greater than or equal to the storage capacity of one page PG of the memory 30. By providing the buffer 12 in the controller 10, it is possible to absorb a difference between a reception rate of the input data signal IN and a transmission rate of the data to the memory 30.

The controller 10 may include a signal processing unit that performs a digital signal processing, such as an averaging process or the like, on the input data signal IN held in the buffer 12. In this case, the buffer 12 may hold the input data signal IN before the signal processing and the input data signal IN after the signal processing.

The memory array 34 of the memory 30 includes a plurality of pages PG, and the cache 32 has the same storage capacity as the storage capacity of the page PG. Although not particularly limited, the storage capacity of one page PG is 256 bytes, for example. The data held in the cache 32 is written to one of the pages PG of the memory array 34.

The pages PG are the data write units. For this reason, in a case where the data to be written is 128 bytes, for example, one-half of the page PG to which the data is written is wasted. In a case where the data is to be efficiently written into the memory array 34, the capacity of the data to be written to each page PG is preferably equal to the storage capacity of the page PG.

The data processing device 100 may be implemented in a sensor that detects one of voltage, current, temperature, light, pressure, geomagnetism, or the like. In this case, the controller 10 receives the input data signal IN indicating the voltage, the current, the temperature, or the like via the external terminal ET. In addition, the data processing device 100 may process a differential input data signal, for example, in place of a single-phase input data signal. Moreover, the data processing device 100 may include a plurality of external terminals ET or a plurality of pairs of differential external terminals ET, in a case where a plurality of information among the voltage, current, temperature, light, pressure, geomagnetism, or the like are to be detected.

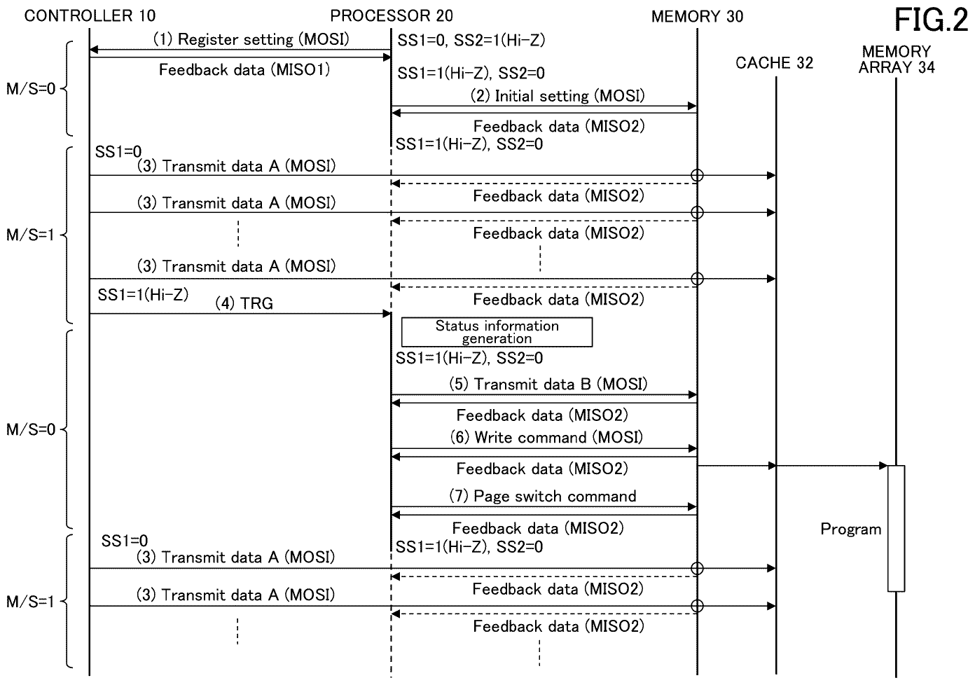

FIG. 2 is a sequence diagram illustrating an example of an operation of the data processing device 100 illustrated in FIG. 1. For example, an operation of the controller 10 is implemented by hardware, and an operation of the processor 20 is implemented by a program (that is, software) executed by the processor 20. The operation illustrated in FIG. 2 is performed in synchronism with the CLK signal output from the processor 20 or the controller 10.

In the operation illustrated in FIG. 2, the transfer of data amounting to one page PG from the controller 10 to the cache 32 of the memory 30, and the writing of data from the cache 32 to a predetermined page PG of the memory array 34 based on an instruction from the processor 20, are performed alternately and repeatedly.

Before step (1), the processor 20 sets the M/S signal to the logical value 0, to switch the controller 10 as the slave and thereafter switch the processor 20 itself as the master. The processor 20 stops the output of the SS2 signal, to set the SS2 signal line to the logical value 1 by a pull-up. The SS1 signal or “1 (Hi-Z)” of the SS2 signal in FIG. 2 indicates that the SS1 signal line or the SS2 signal line in a floating state is set to the logical value 1 by the pull-up.

In step (1), the processor 20 transfers data to the controller 10 via the MOSI line, to perform an initial setting of a register or the like in the controller 10. The processor 20 sets the SS1 signal to the logical value 0 according to a period in which the data is output to the MOSI line. For example, the initial setting relates to a frequency of the CLK signal or an output period of the TRG signal in the case where the controller 10 is the master. The controller 10, in response to receiving initial setting data of the register or the like, and transmits the received data to the processor 20 via the MISO1 line.

After the initial setting of the controller 10, the processor 20 stops the output of the SS1 signal, to set the SS1 signal line to the logical value 1. Next, in step (2), the processor 20 performs an initial setting of the memory 30 via the MOSI line, in a state where the M/S signal is maintained to the logic value 0. The processor 20 sets the SS2 signal to the logical value 0 according to a period in which the data is output to the MOSI line. For example, the initial setting relates to a number of pages PG to which the data is to be written first.

The memory 30 holds a page number (page information) indicating the initially set page PG in the page register PGR. The memory 30 transmits the received data as feedback data to the processor 20 via the MISO2 line. The operations of step (1) and step (2) may be performed in a reverse order.

The processor 20 that performed the initial setting of the memory 30 sets the controller 10 as the master by setting the M/S signal to the logical value 1. The processor 20 maintains the state in which the output of the SS1 signal is stopped and the state in which the SS2 signal is set to the logical value 0 (the selected state of the memory 30), and sleeps. That is, the processor 20 makes a transition from a normal mode to a low power consumption mode. For example, during sleep, the processor 20 stops executing a control program, and accepts nothing other than a hardware interrupt. In FIG. 2, a period of the low power consumption mode of the processor 20 is indicated by a broken line.

The logic of the SS1 signal and the SS2 signal is set using Input/Output (I/O) ports of the controller 10 and the processor 20. For this reason, even during a sleep period of the processor 20, the SS1 signal line or the SS2 signal line can be maintained at a predetermined logical value.

The controller 10 that becomes the master by receiving the M/S signal having the logical value 1, in step (3), sequentially transmits data A held in the buffer 12 to the memory 30. The controller 10 transmits data amounting to one page PG of the memory array 34 to the memory 30. The controller 10 sets the SS1 signal to the logical value 0 according to the period in which the data is output to the MOSI line.

Because the SS1 signal line connects the controller 10 and the processor 20, the SS1 signal is not output to the memory 30 but is output to the sleeping processor 20. However, the memory 30 can be continuously selected as the slave by the SS2 signal having the logical value 0 set by the processor 20. Every time the memory 30 receives the data A from the controller 10, the received data A is stored in the cache 32.

The memory 30 transmits the received data A as feedback data to the processor 20, via the MISO2 line. However, the processor 20 does not receive the feedback data because the processor 20 is sleeping. In a case where the data A amounting to one or more pages PG is held in the buffer 12, the controller 10 may transmit the data A amounting to one page PG to the memory 30 in one serial transfer.

The processor 20 stops executing the program by sleeping, during a period of step (3) in which the data is transferred from the controller 10 to the memory 30. The power consumption of the processor 20 during the sleep period is generated substantially by a power leak. Hence, it possible to significantly reduce the power consumption of the processor 20 compared to the case where the data is transferred to the memory 30 via the processor 20 by the program executed by the processor 20.

The controller 10 that transmits the data A amounting to one page PG to the memory 30 stops the output of the SS1 signal and sets the SS1 signal to the logical value 1. Further, in step (4), the controller 10 controls the I/O port to set the TRG signal line to an active level (for example, the logical value 1). The processor 20 receives the TRG signal having the active level as an interrupt signal, and returns from the low power consumption mode to the normal mode. That is, the processor 20 returns from the sleep.

The processor 20 that returns from the sleep becomes the master, by setting the M/S signal to the logical value 0. The processor 20 generates status information to be transmitted to the memory 30. For example, the status information includes information, such as the temperature of the substrate of the data processing device 100, the voltage used in the data processing device 100, or the like.

The processor 20 stops the output of the SS1 signal, and sets the SS1 signal to the logical value 1.

In step (5), the processor 20 transmits data B including the status information to the memory 30 via the MOSI line. The processor 20 sets the SS2 signal to the logical value 0 according to a period in which the data is output to the MOSI line.

The memory 30 transmits the received data B as feedback data to the processor 20 via the MISO2 line. The processor 20 does not need to generate the status information, and in this case, step (5) may be omitted.

Next, in step (6), the processor 20 transmits a write command to the memory 30 via the MOSI line. The processor 20 sets the SS2 signal to the logical value 0 according to a period in which the data is output to the MOSI line. The memory 30 transmits the received write command as feedback data to the processor 20 via the MISO2 line.

In response to the write command, the memory 30 writes the data amounting to one page PG held in the cache 32 to the page PG indicated by the page number held in the page register PGR (programs the data to the page PG).

By transmitting the write command from the processor 20 to the memory 30, even in a case where the memory 30 is replaced with another memory having a different command specification, it is possible to cope with the replacement by modifying the program to be executed by the processor 20. As a result, the memory 30 can be replaced with another memory having a larger storage capacity, for example, without modifying the substrate in which the controller 10, the processor 20, and the memory 30 are implemented.

In addition, because the processor 20 stops executing the program and sleeps during the period of step (3), the power consumption of the processor 20 required for the data transfer can be reduced to substantially zero. Accordingly, even in the case where the memories 30 of various command specifications are implemented, it is possible to write the data in the memory 30 while reducing an increase in the power consumption of the processor 20.

Next, in step (7), the processor 20 transmits a page switch command to the memory 30 via the MOSI line. The processor 20 sets the SS2 signal to the logical value 0 according to the period in which the data is output to the MOSI line. The memory 30 transmits the received page switch command as feedback data to the processor 20 via the MISO2 line.

The memory 30 updates (for example, increments) the page number held in the page register PGR, in response to the page switch command. The operations of step (6) and step (7) may be performed in a reverse order. In addition, the processor 20 may update the page register PGR to an arbitrary page number. In a case where step (7) is to be performed before step (6), the data held in the cache 32 is written to the page PG updated in step (7).

The processor 20 that transmitted the page switch command to the memory 30 sets the controller 10 as the master by setting the M/S signal to the logical value 1. The processor 20 maintains the state in which the output of the SS1 signal is stopped and the state in which the SS2 signal is set to the logical value 0, and sleeps, similar to the operation after step (2) described above. Thereafter, the operations of step (3) through step (7) described above are repeated, and the data processing device 100 sequentially writes the data received via the external terminal ET in the memory 30 in units of pages PG.

The operations of step (5) through step (7) may be performed in a state where the M/S signal is held at the logical value 1. In this case, the controller 10 controls the I/O port to set the TRG signal line to the active level, and stops the output of the CLK signal and the MOSI signal (sets to Hi-Z). The active state of the TRG signal and the stopped state of the output of the CLK signal and the MOSI signal are continued until the next data is transmitted to the memory 30.

Even in the case where the M/S signal is held at the logical value 1, the processor 20 receives the TRG signal having the active level as an interrupt signal, and returns from the low power consumption mode to the normal mode. That is, the processor 20 returns from sleep. The processor 20 that returned from sleep generates the status information to be transmitted to the memory 30, while the TRG signal is in the active state. Moreover, the processor 20 transmits the data B including the status information, the write command, and the page switch command to the memory 30 via the MOSI line.

The processor 20 that transmitted the page switch command to the memory 30 stops the output of the CLK signal and the MOSI signal, maintains a state in which the output of the SS1 signal is stopped and a state in which the SS2 signal is set to the logical value 0, and sleeps. Thereafter, the controller 10 resumes the output of the CLK signal and the MOSI signal according to the output of the next transmission data, and performs step (3). That is, the operations of step (3) through (7) are repeatedly performed in a state where the M/S signal is set to the logical value 1. Hence, after the transmission of the data from the controller 10 to the memory 30 is started, it is unnecessary to switch the M/S signal, thereby simplifying the data transfer control.

Further, the operations of step (5) through step (7) may be performed during intervals between a plurality of successive data transfers from the controller 10 to the memory 30, in a state where the M/S signal is held at the logical value 1. In this case, the controller 10 continuously performs the data transfer to the memory 30 in step (3) at a predetermined period. Moreover, the controller 10 stops the output of the CLK signal and the MOSI signal (sets to Hi-Z) during a period until the next data is transferred to the memory 30 after setting the TRG signal to the active level.

For example, the predetermined period is a period in which the controller 10 receives the input data signal IN via the external terminal ET. In a case where the controller 10 includes an analog-to-digital converter that converts the analog input data signal IN into a digital value, the predetermined period is a sampling period of the analog-to-digital converter, for example.

The processor 20 is aware of the period of the data transfer from the controller 10 to the memory 30 in advance. In addition, the processor 20 generates the status information and performs the operations of step (5) through step (7) during a period until the next data transfer from the controller 10 to the memory 30 after receiving the TRG signal having the active level. In a case where it takes time to perform the process of generating the status information, the processor 20 may transmit the page switch command to the memory 30, thereafter generate the status information, and sleep. In this case, the processor 20 transmits the generated status information to the memory 30 based on receiving the next TRG signal having the active level.

By setting the period of the data transfer to the memory 30 to the period at which the input data signal IN is received via the external terminal ET, the input data signal IN can be received continuously at a constant period. In addition, the controller 10 does not need to hold the data amounting to one page PG in the buffer 12. For this reason, the capacity of the buffer 12 can be minimized to the capacity used for the digital signal processing of the input data signal IN.

In a case where the controller 10 is switched to the slave during the period in which step (5) through step (7) are performed using the M/S signal, the sampling period of the controller 10 may deviate. Thus, if a data transfer timing to the memory 30 deviates with respect to a sampling timing of the input data signal IN, the data transfer to the memory 30 may not be performed in a normal manner.

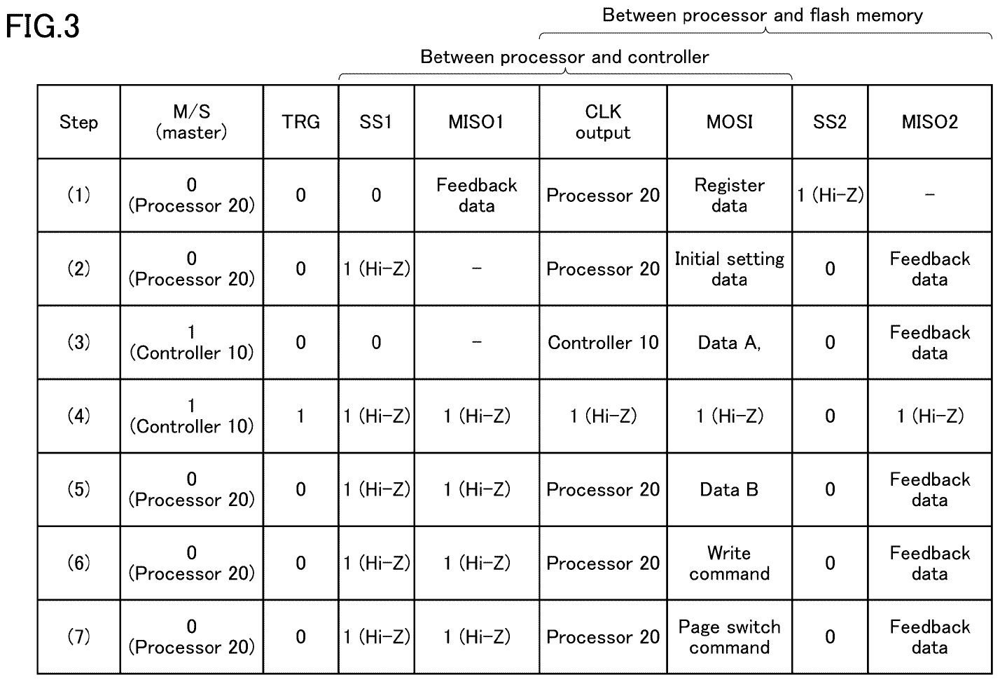

FIG. 3 is an explanatory diagram illustrating an example of the state of a signal in each step of the operation sequence of FIG. 2. Because the CLK signal, the MOSI signal, the MISO1 signal, the MISO2 signal, the SS1 signal, and the SS2 signal are bi-directional signals, when these signals are not used, these signals are set to the high impedance state Hi-Z as described above, and are set to the logical value 1 by the pull-up. In each step, the SS1 signal is set to the logical value 0 only while the master is transferring the data. The SS2 signal is set to the logical value 0 only while the master is transferring the data, except in step (3). The SS2 signal is fixed to the logical value 0 in step (3).

As described above, in the present embodiment, the processor 20 does not control the transfer of the data to the memory 30, but controls the transmission of the write command to the memory 30. Thus, even in the case where the memory 30 is replaced with another memory having a different command specification, for example, it is possible to cope with the replacement by modifying the program to be executed by the processor 20. As a result, even in the case where one of memories having the various command specifications is implemented, it is possible to provide a data processing device capable of writing the data in the memory while reducing an increase in the power consumption of the processor 20.

The processor 20 stops the executing the program by sleeping during the period of step (3) in which the data is transferred from the controller 10 to the memory 30. The processor 20 cancels the sleep based on the TRG signal output from the controller 10 after the transfer of the predetermined amount of data to the memory 30. The power consumption of the processor 20 during the sleep period is substantially zero. This makes it possible to significantly reduce the power consumption of the processor 20 compared to the case where the data is transferred to the memory 30 by the program executed by the processor 20.

In addition, because the processor 20 stops executing the program and sleeps during the period of step (3), the power consumption of the processor 20 required for the data transfer can be reduced to substantially zero. Accordingly, even in the case where the memories 30 having the various command specifications are implemented, it is possible to write the data in the memory 30 while reducing an increase in the power consumption of the processor 20.

The data A is transferred from the controller 10 to the memory 30, and the register data is transmitted from the processor 20 to the controller 10, using the MOSI signal line which is a common serial data line. In addition, the initial setting data, the data B, the write command, and the page switch command are transmitted from the processor 20 to the memory 30, using the common MOSI signal line. Thus, the operations illustrated in FIG. 2 and FIG. 3 can be performed by forming a minimum number of interconnects on the substrate in which the controller 10, the processor 20, and the memory 30 are implemented. As a result, the size of the substrate can be reduced, and the cost of the data processing device 100 can be reduced.

The controller 10 outputs the TRG signal to the processor 20 and causes the processor 20 to transmit the write command every time the data A corresponding to the storage capacity of the page PG is transferred to the memory 30. Thus, the data A can be written into the memory array 34 in units of pages PG, and the data A can be efficiently written into the memory array 34.

The processor 20 updates the page register PGR according to the writing of the data A into the memory array 34. Hence, the data A can be sequentially written into the plurality of pages PG of the memory array 34, without causing the controller 10 to recognize the pages PG to which the data A is to be written.

By providing the buffer 12 for holding the data A in the controller 10, a reception timing of the input data signal IN from the external terminal ET, and a transfer timing of the data A from the controller 10, can be made asynchronous to each other. For example, the controller 10 can hold the data A in the buffer 12, so that the reception timing of the last data A amounting to one page PG and the transmission timing of the last data A to the memory 30 match. As a result, the data A can be transmitted to the memory 30 in units of pages PG, regardless of a reception rate of the input data signal IN from the external terminal ET, and the data A can be efficiently written into the memory array 34.

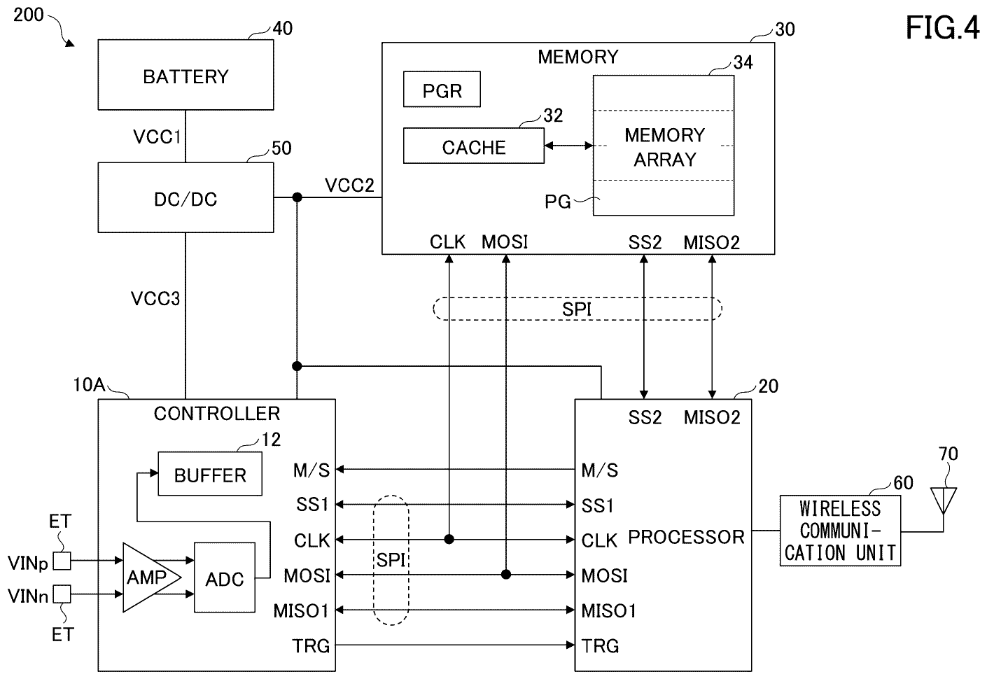

FIG. 4 is an overall block diagram illustrating an example of a biological sensor according to an embodiment. A detailed description of elements that are the same or similar as those elements illustrated in FIG. 1 will be omitted. A biological sensor 200 illustrated in FIG. 4 includes a controller 10A in place of the controller 10 illustrated in FIG. 1. The biological sensor 200 includes a battery 40, a DC/DC converter 50, a wireless communication unit 60, and an antenna 70, in addition to the configuration of the data processing device 100 of FIG. 1. The processor 20 and the memory 30 are the same as or similar to the processor 20 and the memory 30 of FIG. 1, respectively. For example, the biological sensor 200 is a wearable device capable of acquiring biological information from a living body. In addition, the biological sensor 200 functions as a data processing device that receives the biological information as the data.

The controller 10A includes an amplifier AMP, an analog-to-digital converter ADC, and a buffer 12. The controller 10A receives a biological signal from the living body as a differential input voltage signal VINp/VINn via a pair of external terminals ET of the data processing device 100. The biological signal is the biological information indicating one of an electrocardiogram waveform, an electroencephalogram, a pulse, a blood pressure, an oxygen saturation, a body temperature, a heart sound, a breath sound, or the like, for example. The biological sensor 200 may receive a plurality of biological signals of the same type through a plurality of terminal pairs, or may receive biological information of different types through a plurality of terminal pairs.

The amplifier AMP differentially amplifies the input voltage signal VINp/VINn received by the pair of external terminals ET, and outputs the amplified differential signal to the analog-to-digital converter ADC. The analog-to-digital converter circuit ADC converts the differential signal received from the amplifier AMP into digital data. The controller 10A sequentially stores the digital data generated by the analog-to-digital converter ADC circuit in the buffer 12.

The battery 40 outputs a power supply voltage VCC1 to the DC/DC converter 50. The DC/DC converter 50 generates power supply voltages VCC2 and VCC3 using the power supply voltage VCC1. For example, the power supply voltage VCC2 is used as an operating power supply of the processor 20 and the memory 30, and is used as an operating power supply of a digital circuit implemented in the controller 10A. For example, the power supply voltage VCC3 is used as an operating power supply of an analog circuit, such as the amplifier AMP, the analog-to-digital converter circuit ADC, or the like implemented in the controller 10. A power supply voltage for programming the data may be supplied to the memory 30. In this case, the DC/DC converter 50 may generate the power supply voltage for programming.

The wireless communication unit 60 communicates with an external device disposed outside the biological sensor 200 via the antenna 70, based on a control from the processor 20. For example, the processor 20 transmits the biological information held in the memory 30 to the external device via the wireless communication unit 60.

The operations of the controller 10A, the processor 20, and the memory 30 are the same as those illustrated in FIG. 2 and FIG. 3. The controller 10A may be implemented in an ASIC or an FPGA.

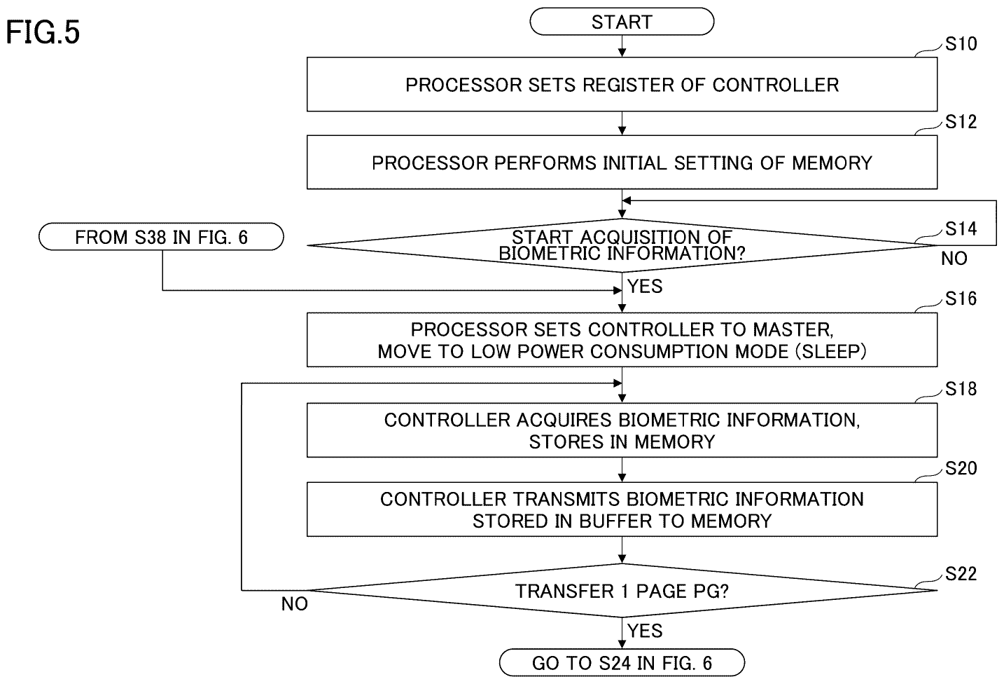

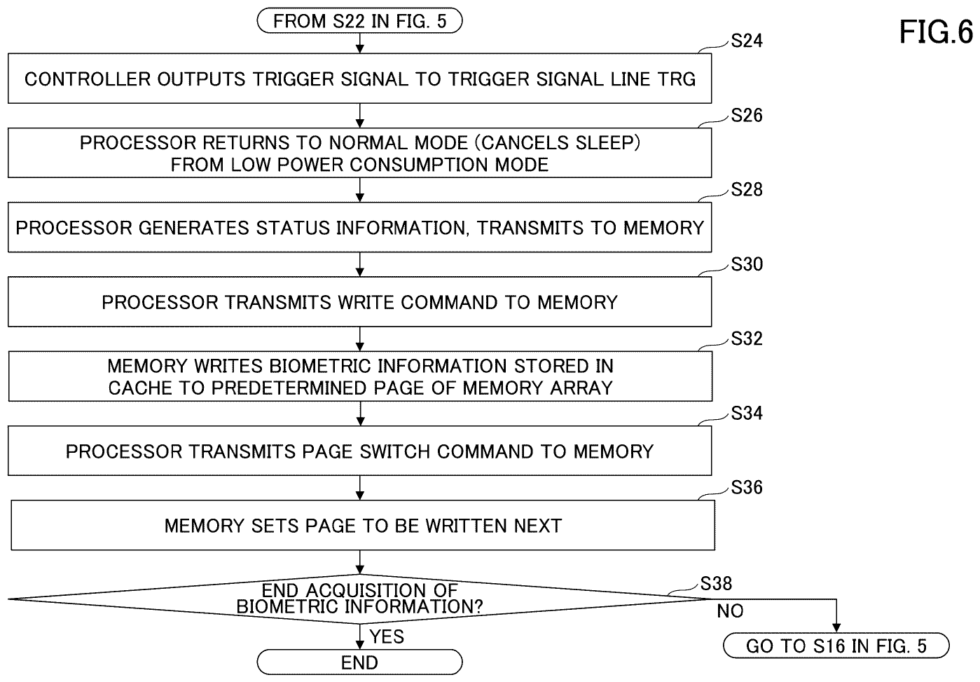

FIG. 5 and FIG. 6 are flow charts illustrating an example of the operation of the biological sensor 200 of FIG. 4. First, in step S10, the processor 20 sets the register of the controller 10A, similar to step (1) of FIG. 2 and FIG. 3. Next, in step S12, the processor 20 performs an initial setting of the memory 30, similar to step (2) of FIG. 2 and FIG. 3.

Next, in step S14, the processor 20 waits for a start instruction to start acquisition of the biological information from the outside of the biological sensor 200. In a case where the processor 20 receives the start instruction, the processor 20 performs step S16. For example, the processor 20 receives the start instruction via the wireless communication unit 60. In step S16, the processor 20 sets the controller 10A as the master, and switches from the normal mode to the low power consumption mode (sleep).

Next, in step S18, the controller 10A acquires the biological information, and stores the acquired biological information in the buffer 12. Next, in step S20, the controller 10A transmits the biological information stored in the buffer 12 to the memory 30, similar to step (3) of FIG. 2 and FIG. 3.

Next, in step S22, the controller 10A determines whether or not the biological information amounting to one page PG is transferred to the memory 30. In a case where the biological information amounting to one page PG is transferred to the memory 30, the controller 10A performs step S24 of FIG. 6. In a case where the biological information amounting to one page PG is not transferred to the memory 30, the controller 10A performs step S18.

In step S24 of FIG. 6, the controller 10A outputs the trigger signal TRG having the active level to the trigger signal line TRG, similar to step (4) of FIG. 2 and FIG. 3. Next, in step S26, the processor 20 returns from the low power consumption mode to the normal mode based on the TRG signal (cancels sleep).

Next, in step S28, the processor 20 generates status information, and transmits the generated status information to the memory 30, similar to step (5) of FIG. 2 and FIG. 3. Next, in step S30, the processor 20 transmits the write command to the memory 30, similar to step (6) of FIG. 2 and FIG. 3. Next, in step S32, the memory 30 that receives the write command writes the biological information held in the cache 32 to the page PG indicated by the page number held in the page register PGR among the plurality of pages PG of the memory array 34.

Next, in step S34, the processor 20 transmits the page switch command to the memory 30, similar to step (7) of FIG. 2 and FIG. 3. Next, in step S36, the memory 30 that receives the page switch command updates the page number held in the page register PGR, thereby setting the page PG to which the biological information is to be written next.

Next, in step S38, the processor 20 determines whether or not an end instruction to end the acquisition of the biological information from the outside of the biological sensor 200 is received. For example, the processor 20 receives the end instruction via the wireless communication unit 60. In a case where the processor 20 receives the end instruction, the processor 20 ends the operation of acquiring the biological information illustrated in FIG. 5 and FIG. 6. In a case where the processor 20 does not receive the end instruction, the processor 20 performs step S16 of FIG. 15. The biological sensor 200 receives the end instruction to end the acquisition of the biological information at an arbitrary timing, but performs the operation up to step S38 regardless of the reception timing of the end instruction, and ends the operation of acquiring the biological information. Thus, the biological information can be written into the memory array 34 in units of pages PG.

As described above, the same effects as those obtainable by the data processing device 100 illustrated in FIG. 1 through FIG. 3 can be obtained in the present embodiment. For example, the processor 20 does not control the transfer of the biological information to the memory 30, but controls the transmission of the write command to the memory 30. Hence, even in the case where the memory 30 is replaced with another memory having a different command specification, for example, it is possible to cope with the replacement by modifying the program to be executed by the processor 20. As a result, even in the case where one of memories having various command specifications is implemented, it is possible to provide the biological sensor 200 capable of writing the biological information into the memory while reducing an increase in the power consumption of the processor 20.

The processor 20 sleeps during a period in which the biological information is transferred from the controller 10 to the memory 30, and cancels the sleep based on the TRG signal output from the controller 10 after a predetermined amount of biological information is transferred to the memory 30. This makes it possible to significantly reduce the power consumption of the processor 20 compared to the case where the data is transferred to the memory 30 by a program executed by the processor 20.

The biological information, the data, the write command, or the page switch command is transmitted from the controller 10 to the memory 30, from the processor 20 to the controller 10, and from the processor 20 to the memory 30, using the MOSI signal line which is a common serial data line. Thus, the operations illustrated in FIG. 5 and FIG. 6 can be performed with a minimum number of interconnects formed on the substrate in which the controller 10, the processor 20, and the memory 30 are implemented. As a result, the size of the substrate can be reduced, and the cost of the biological sensor 200 can be reduced.

The controller 10 outputs the TRG signal to the processor 20 and causes the processor 20 to transmit the write command every time the biological information corresponding to the storage capacity of the page PG is transferred to the memory 30. Thus, the biological information can be written into the memory array 34 in units of pages PG, and the biological information can be efficiently written into the memory array 34.

The processor 20 updates the page register PGR according to the writing of the biological information into the memory array 34. Thus, the biological information can be sequentially written into the plurality of pages PG of the memory array 34, without causing the controller 10 to recognize the page PG to which the biological information is to be written.

By providing the buffer 12 that holds the biological information in the controller 10, it is possible to make the reception timing of the input voltage signal VINp/VINn from the input voltage signal terminal VINp/VINn and the transfer timing of the biological information from the controller 10 asynchronous to each other. As a result, the biological information can be transmitted to the memory 30 in units of pages PG regardless of the reception rate of the input voltage signals VINp/VINn from the input voltage signal terminals VINp/VINn, and the biological information can be efficiently written into the memory array 34.

Although the present invention is described based on the embodiments, the present invention is not limited to the specifically disclosed embodiments, and modifications can be made without departing from the subject matter of the present invention.

Aspects of the present invention include the following, for example.

<1> A data processing device characterized in that there are provided:
a memory including a first buffer configured to hold data and a memory array, the memory being configured to write the data held in the first buffer to the memory array based on receiving a write command;
a controller configured to transfer data received from an outside to the first buffer, and output a trigger signal based on transfer of a predetermined amount of data to the first buffer; and
a processor configured to transmit the write command to the memory based on receiving the trigger signal.

<2> The data processing device according to <1>, characterized in that:
the controller, the processor, and the memory are coupled to one another via a common data line,
the processor includes a function to output a chip select signal for selecting the memory to a chip select terminal of the memory, and
the processor that transmits the write command to the memory sets the chip select signal to a state of selecting the memory, thereafter sleeps, and returns from sleep based on receiving the trigger signal.

<3> The data processing device according to <2>, characterized in that:
the common data line is a serial data line,
the controller transmits the data to the memory via the serial data line, and
the processor transmits the write command to the memory via the serial data line.

<4> The data processing device according to any one of <1> to <3>, characterized in that:
the memory array includes a plurality of pages that are data writing units, and
the predetermined amount of data transferred to the first buffer by the controller is an amount of data corresponding to a storage capacity of each of the plurality of pages.

<5> The data processing device according to <2> or <3>, characterized in that:
the memory array includes a plurality of pages to which data is written,
the memory includes a page register that holds page information indicating a page of the memory array to which data is written, and
the processor updates the page information held by the page register before the processor sleeps.

<6> The data processing device according to any one of <1> to <4>, characterized in that the controller includes a second buffer configured to hold data received from an external terminal before transferring the data to the first buffer, and transfers the data held in the second buffer to the first buffer.

<7> A biometric sensor characterized in that there are provided:
a memory including a first buffer configured to hold data and a memory array, the memory being configured to write the data held in the first buffer to the memory array based on receiving a write command;
a controller configured to transfer data received from an outside to the first buffer, and output a trigger signal based on transfer of a predetermined amount of data to the first buffer; and
a processor configured to transmit the write command to the memory based on receiving the trigger signal.

This application is based upon and claims priority to Japanese Patent Application No. 2022-133919, filed on Aug. 25, 2022 before the Japan Patent Office, the entire contents of which are incorporated herein by reference.

### DESCRIPTION OF REFERENCE NUMERALS

10, 10A: Controller
12: Buffer
20: Processor
30: Memory
32: Cache
34: Memory array
40: Battery
50: DC/DC converter
60: Wireless communication unit
70: Antenna
100: Data processing device
200: Biological sensor
AMP: Amplifier
ADC: analog-to-digital converter
ET: External terminal
IN: Input data signal
PG: Page
PGR: Page register
VINp/VINn: Input voltage signal

1. A data processing device comprising:
a memory including a first buffer configured to hold data and a memory array, the memory being configured to write the data held in the first buffer to the memory array based on receiving a write command;
a controller configured to transfer data received from an outside to the first buffer, and output a trigger signal based on transfer of a predetermined amount of data to the first buffer; and
a processor configured to transmit the write command to the memory based on receiving the trigger signal.

2. The data processing device as claimed in claim 1, wherein:
the controller, the processor, and the memory are coupled to one another via a common data line,
the processor includes a function to output a chip select signal for selecting the memory to a chip select terminal of the memory, and
the processor that transmits the write command to the memory sets the chip select signal to a state of selecting the memory, thereafter sleeps, and returns from sleep based on receiving the trigger signal.

3. The data processing device as claimed in claim 2, wherein:
the common data line is a serial data line,
the controller transmits the data to the memory via the serial data line, and
the processor transmits the write command to the memory via the serial data line.

4. The data processing device as claimed in claim 1, wherein:
the memory array includes a plurality of pages that are data writing units, and
the predetermined amount of data transferred to the first buffer by the controller is an amount of data corresponding to a storage capacity of each of the plurality of pages.

5. The data processing device as claimed in claim 2, wherein:
the memory array includes a plurality of pages to which data is written,
the memory includes a page register that holds page information indicating a page of the memory array to which data is written, and
the processor updates the page information held by the page register before the processor sleeps.

6. The data processing device as claimed in claim 1, wherein the controller includes a second buffer configured to hold data received from an external terminal before transferring the data to the first buffer, and transfers the data held in the second buffer to the first buffer.

7. A biometric sensor comprising:
a memory including a first buffer configured to hold data and a memory array, the memory being configured to write the data held in the first buffer to the memory array based on receiving a write command;
a controller configured to transfer data received from an outside to the first buffer, and output a trigger signal based on transfer of a predetermined amount of data to the first buffer; and
a processor configured to transmit the write command to the memory based on receiving the trigger signal.
